(19) United States
(12) Patent Application Publication
(10) Pub. No.: US 2020/0018571 A1
(43) Pub. Date: Jan. 16, 2020

(54) SHOOTING SYSTEM AND METHOD USING DRONE

(71) Applicant: Jong Jean KANG, Ulsan (KR)

(72) Inventor: Jong Jean KANG, Ulsan (KR)

(21) Appl. No.: 16/469,121

(22) PCT Filed: Jul. 12, 2017
(86) PCT No.: PCT/KR2017/007425

§ 371 Date: Jun. 12, 2019

(30) Foreign Application Priority Data
Dec. 13, 2016 (KR) 10-2016-0169131

(51) Int. Cl. F41G 3/26; F41J 5/24; F41J 9/08; B64C 39/02

(52) U.S. Cl. CPC F41G 3/2655; F41J 5/24; B64C 2201/027; B64C 39/02; B64C 2201/12; F41J 9/08

(57) ABSTRACT

The present invention relates to a shooting system using a drone, and disclosed is a shooting system using a drone, which comprises a laser gun and a sensor capable of receiving laser light instead of a shotgun and a pigeon used in a conventional clay shooting, wherein the laser gun comprises a firing recoil unit and a firing sound unit and the takeoff/landing and flight trajectory of the drone are controlled on the ground, thereby maintaining the advantages of clay shooting while eliminating risk factors related to the use of a shotgun and improving the problems of treating a damaged pigeon.

### TECHNICAL FIELD

The present invention relates to a shooting system using a drone and a shooting method, and more particularly to a shooting system using a drone which uses a drone including a laser gun and a sensor which can receive laser light instead of a shotgun and a pigeon which are used in a conventional clay shooting, wherein the laser gun includes a shooting vibration unit and a shooting sound unit, and controls taking-off/landing and a trajectory of the drone on the ground, thereby removing a risk factor according to use of a shotgun while maintaining the advantage of the clay shooting and solving the problems according to treatment of a damaged pigeon, and a shooting method.

### BACKGROUND ART

A clay shooting is a leisure sport game in which a clay pigeon target made by mixing lime and pitch is flown and is shot by a shotgun, and victory and defeat are divided according to the number of broken clay pigeon targets. For a clay shooting, because a gun using case shots containing lead is used, a risk of kill and wound is always present, and an environmental contamination problems has been issued as the broken pigeon residues are accumulated in the shooting gallery. Further, the clay shooting is limited to an age of 14 or more due to the problems of danger and contamination and conditions of the clay shooting are extremely restrictive as it can be performed in a limited shooting gallery so that it is difficult to expand the clay shooting as leisure sports.

### PRIOR TECHNICAL DOCUMENTS

### Patent Documents

### Korean Patent No. 10-0983601

### DETAILED DESCRIPTION OF THE INVENTION

### Technical Problem

The present invention is provided to solve the above-mentioned problems of the conventional technologies.

The present invention provides a shooting system using a drone which can replace a clay pigeon target seriously causing environmental contamination with a drone which can take off or land and replace a lead shotgun having a risk of environmental contamination, and kill and wound with a laser gun, thereby allowing a user to enjoy a shooting safely, and a shooting method.

The present invention also provides a shooting system using a drone which can receive laser light from a laser gun in order to solve the problems of a clay shooting using a gun using actual shots which are restricted to a specific shooting gallery and have to be kept in public institutes, and a shooting method.

### Technical Solution

In order to achieve the above-described objects, a shooting system and a shooting method using a drone according to an embodiment of the present invention include a laser gun configured to generate laser light, a drone including a photo sensor configured to receive the laser light fired by the laser gun, and a control unit configured to control taking-off/landing and a flight trajectory of the drone and, which the photo sensor receives the laser light, control a flight mode such that the drone is shot down.

Further, the laser gun includes a laser pointer unit configured to fire the laser light, a firing vibration unit configured to generate vibration according to a shooting as a portion of the laser gun is moved back when the laser light is fired, and a firing sound unit configured to generate a sound when the laser light is fired.

Further, the control unit generates a shooting-down effect according to a program stored in advance when the drone receives the laser light through transmission and reception of signals to and from a ground station.

### Advantageous Effects of the Invention

As described above, according to the shooting system using a drone and the shooting method according of the embodiments of the present invention, everyone can safely enjoy the shooting game while maintaining the advantages of the clay shooting by replacing a shotgun and a pigeon of the clay shooting with a laser gun and a drone.

Further, the shooting system using a drone according to the embodiment of the present invention can replace the conventional pigeon, of which the material is lime pitch, with a drone, thereby reducing environmental contamination, and can replace the shotgun with a laser gun, thereby allowing the users to enjoy shootings as a safe leisure sport.

### DESCRIPTION OF THE DRAWINGS

FIG. 1 is a schematic view illustrating a configuration of a shooting system using a drone according to an embodiment of the present invention.

FIG. 2 is a perspective view illustrating the external shape of the drone according to the embodiment of the present invention.

FIG. 3 is a plan view illustrating the internal structure of the drone according to the embodiment of the present invention.

FIG. 4 is a perspective view illustrating the external shape of a laser gun according to the embodiment of the present invention, in which FIG. 3B is a perspective view illustrating an operation of a firing vibration unit of the laser gun.

FIG. 5 is a block diagram for explaining control of the shooting system using a drone according to the embodiment of the present invention.

FIG. 6 is a block diagram illustrating a shooting method using a drone according to an embodiment of the present invention.

### BEST MODE

Hereinafter, a configuration of a shooting system using a drone according to an embodiment of the present invention will be described in detail with reference to the accompanying drawings.

Although it will be described as an example in the embodiment of the present invention, for convenience of description, that the drone has a multi-copter form in which a plurality of rotary wing parts are coupled to an outer surface of the body, the present invention is not limited thereto, it is apparent that various kinds of unmanned flying objects having different forms may be applied to the technical spirit of the present invention.

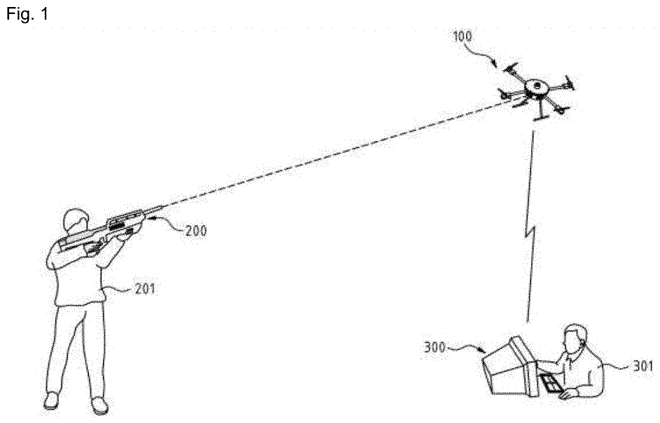

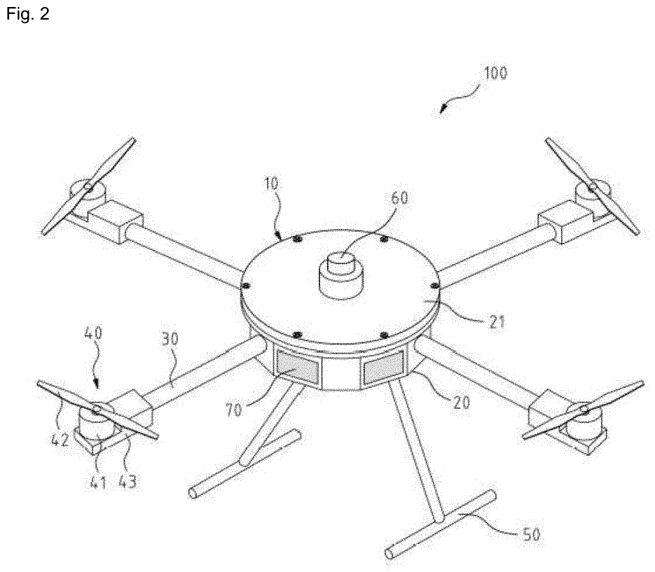

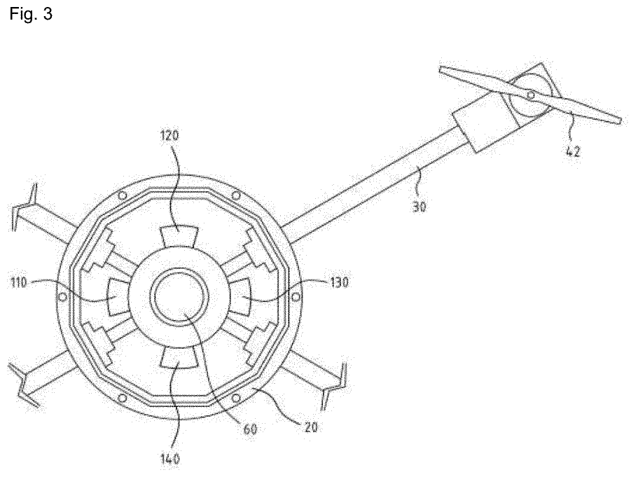

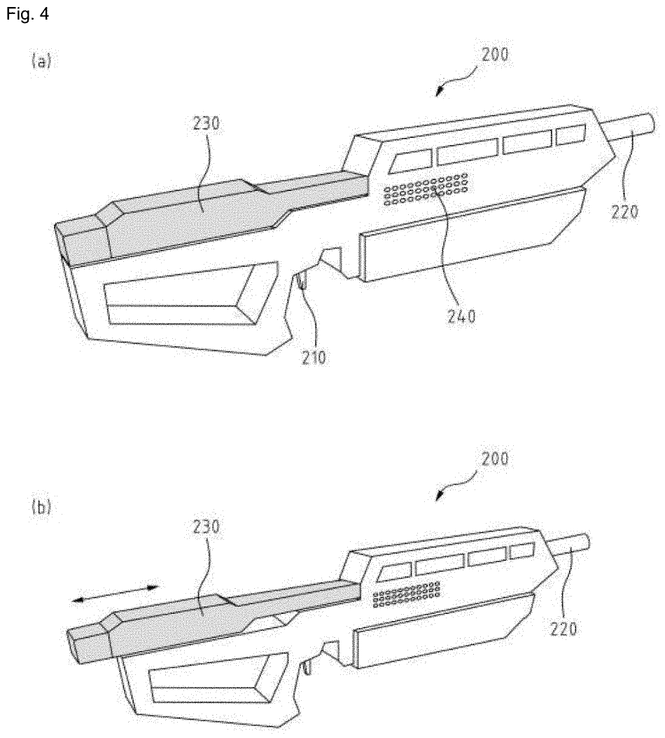

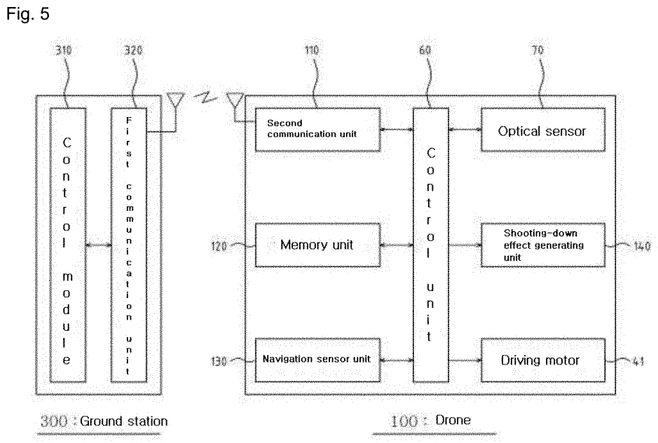

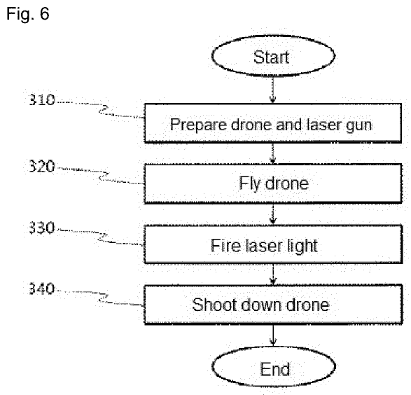

FIG. 1 is a schematic view illustrating a configuration of a shooting system using a drone according to an embodiment of the present invention. FIG. 2 is a perspective view illustrating the external shape of the drone according to the embodiment of the present invention. FIG. 3 is a plan view illustrating the internal structure of the drone according to the embodiment of the present invention. FIG. 3A is a perspective view illustrating the external shape of the laser gun according to the embodiment of the present invention. FIG. 3B is a perspective view illustrating an operation of a firing vibration unit of the laser gun. FIG. 4 is a block diagram for explaining control of the shooting system using a drone according to the embodiment of the present invention. FIG. 5 is a block diagram for explaining control of the shooting system using a drone according to the embodiment of the present invention. FIG. 6 is a block diagram illustrating a shooting method using a drone according to an embodiment of the present invention.

The shooting system using a drone according to an embodiment of the present invention includes a drone 100 programmed in advance to fly, a laser gun 200 configured to fire laser light through a control by a user 201, and a ground station 300 configured to control the flight of the drone according to whether the drone 100 has detected the laser light or not.

The drone 100 includes a body 10, a plurality of connecting arms 30, a plurality of rotary wing parts 40, a support 50, and a control unit 60.

The body 10 includes a tubular body housing 20 having a substantially circular, elliptical, or polygonal cross-section, and a cover 21 coupled to an upper portion of the body housing 20 with screws, bolts/nuts, rivets, and the like.

The body 10 is provided with a plurality of connecting arms 30 radially connected to a side surface of the body 10, and a plurality of rotary wing parts 40 coupled to ends of the connecting arms 30, respectively.

A support 50 for maintaining the posture of the drone when the drone 100 lands on the ground is disposed at a lower portion of the body 10.

Meanwhile, the connecting arms 30 and the support 50 are configurations which may be selectively added, and some configurations of the drone 100 may be omitted according to the form of the drone 100.

Meanwhile, as described below, a plurality of photo sensors 70 for detecting the laser light are installed in areas of the side surface of the body housing 20, except for the rotary wing parts 40.

However, although it has been described as an example that the photo sensor 70 according to the embodiment of the present invention is provided on the side surface of the body housing 20, the present invention is not limited thereto, and may be provided at a lower portion of the body 10, and the cover 21 or the rotary wing parts 40.

Each of the rotary wing parts 40 includes a driving motor 41 configured to provide a rotational force with electric power, a rotary wing 42 coupled to be rotatable by the driving motor 41 to provide a flying force to the drone 100, and a rotary wing mounting part 43, on which the motor 41 and the rotary wing 42 are fixed and mounted.

Then, it is preferable that the driving motor 41 includes a motor (as an example, a BLDC motor), of which a rotational force may be controlled such that the rotational force of the rotary wing may be controlled for movement of the location of the drone or control of the posture of the drone if necessary.

Meanwhile, the drone 100 according to the embodiment of the present invention includes a control unit 60 configured to control an operation of a flying object, and the control unit 60 receives taking-off/landing and flight information through communication with the ground station 300, and accordingly, controls an operation of the driving motor 41.

Further, the control unit 60 controls the drone 100 to be shot down (or landed) according to a program input in advance when the user 201 controls the laser gun 200 and the photo sensor 70 detects the fired laser light.

The program includes taking-off/landing and a flight trajectory of the drone 100, and the difficulty and stage of the shooting can be adjusted by stages by inputting a plurality of flight trajectories according to the location of the photo sensor 70 which receives the laser light, the height of the drone 100, or the like.

Further, when the drone 100 is shot down, the control unit 60 generates various shooting-down effects, such as a sound, light or smoke, by controlling a shooting-down effect generating unit 140 according to the program so that a realistic shooting system which conforms with the taste or preference of the user can be realized unlike a conventional simple destruction of pigeon.

Further, the ground station 300 includes a control module 310 configured to control the shooting system according to the present invention, and a first communication unit 320 configured to transmit and receive signals to and from the drone 100 according to a command of the control module 310.

Accordingly, the control unit 60 of the drone 100, which received a signal transmitted from the ground station 300, receives the signal received from the first communication unit 320 through a second communication unit 110, and controls all items, such as the flight of the drone 10, detection and shooting-down of the laser light, and the like, by using the signal.

The ground station 300 controls a flight mode such that individual drones fly in various schemes or a plurality of drones form a set or scatter to perform a formation flight, by making the flight speed, the flight height, and the flight path of the drone 100 through a program embedded in a memory unit 120 of the control unit 60 in advance and a navigation photo sensor 130.

Meanwhile, the laser gun 200 includes a laser pointer 220 configured to fire laser light if the user pulls a trigger 210 to start a shooting, a firing vibration unit 230 configured to generate vibration due to firing as a portion of a gun barrel is moved back at the same time when the laser light is fired, and a firing sound unit 240 configured to generate various firing sounds together with the firing.

The laser gun 200 may be manufactured by using a 3D printer, and in this case, manufacturing costs of the gun remarkably decrease and various forms of guns may be manufactured, in which case the gun can be variously selected according to the taste of the user.

Further, the firing vibration unit 230 and a firing sound generating unit 240 may be manufactured with modules to be assembled in the body of the laser gun 200 so that they can be easily attached and detached, and repaired.

The laser pointer 220 is a high-performance laser pointer which may reach a distance of up to about 2 km so that various shooting modes may be experienced as short-distance and long-distance shooting are possible according to the flight distance or height of the drone 100.

The firing vibration unit 230 is coupled to an upper portion of the rear side of the body of the laser gun 200 in a sliding manner, and is configured to return to the original position after being moved back by using a known scheme, such as an elastic force of a spring or a pneumatic pressure.

The firing sound generating unit 240 selectively generates various firing sounds of the gun as well as a firing sound of a shotgun at the same time when the laser light is fired, and acoustic effects that are similar to those of actual shooting may be realized by adjusting the magnitude or interval of the firing sounds.

The laser gun 200 may generate and fire laser light, and includes all forms of signals, such as various forms of coded signals, visual rays, non-visual rays, and electric waves, by which firing of the laser gun 200 and a firing signal of the drone 100 may be transmitted and received.

Through the firing vibration unit 230 and the firing sound generating unit 240, the user can experience a repulsive movement and a firing sound by firing, which are similar to those of an actual gun so that a realistic shooting effect can be realized.

Further, When the above-mentioned shooting system using a drone according to the present invention is used, the user inputs an intrinsic code to a selected laser gun and links the control module 310 of the ground station 300 to an app of a smartphone to allow the user to identify a shooting score and a ranking of the user on the internet according to a difficulty level and a stage so that a shooting game may be realized even when the shooting site and the users are different.

The shooting system using a drone having the above configuration includes a preparation step 310, a flight step 320, a firing step 330, and a shooting-down step 340.

First, the preparation step 310 is provided. The preparation step 310 is a step of preparing a drone 100 and a laser gun 200. The control unit 60 formed in the interior of the drone 100 sets taking-off/landing and a flight trajectory, and a photo sensor 70 for receiving laser light is provided. The laser gun 200 includes a laser pointer unit 220, a firing vibration unit 230, and a firing sound unit 240.

Next, the flight step 320 is provided. The flight step 320 is a step of flying the drone 100. The drone 100 flies in a preset flight trajectory.

Next, the shooting step 330 is provided. The shooting step 330 is a step of firing laser light toward the drone which is flying with the laser gun 200. The laser gun 200 fires laser light and generates a firing sound in the firing sound unit 240, and after the firing, the firing vibration unit 230 generates vibration. The vibration refers to forward and rearward movements of the laser gun 200. The firing sound and the vibration allow the laser gun 200 to show an effect that is similar to that of an actual gun.

Next, the shooting-down step 340 is provided. In the shooting-down step 320, the drone 100 is shot down when the drone 100 receives the laser light. That is, the drone 100 determines whether the laser light has been received or not in the photo sensor 70, and determines shooting-down when receiving the laser light. When the drone 100 is not shot down, the drone 100 may fly in a preset flight trajectory corresponding to the case in which the drone 100 is not shot down or no event may occur.

Next, if the drone 100 is shot down in the shooting-down step 340, the drone 100 can further include a step in which the drone 100 can fly in a flight trajectory set separately after the shooting-down and a score according to the shooting-down is added.

The above-mentioned shooting system using a drone according to the embodiment of the present invention can replace the shotgun and the pigeon in the conventional clay shooting with a laser gun and a drone, there by maintaining the advantages of the clay shooting and allowing everyone to safely enjoy the shooting.

Further, the shooting system using a drone according to the embodiment of the present invention can replace the conventional pigeon, of which the material is lime pitch, thereby reducing environmental contamination, and can replace the shotgun with a laser gun, thereby allowing the users to enjoy shootings as a safe leisure sport.

Further, the shooting system using a drone according to the embodiment of the present invention can generate a sound and a firing vibration according to firing of the laser gun, can selectively control a flight mode of the drone, and can generate various effects that are similar to those of the reality while the drone is shot down according to the detection of the laser light, thereby realizing a realistic shooting system.

Further, the shooting system using a drone according to the embodiment of the present invention can realize user-specific guns of various forms because the laser gun is manufactured by using a 3D printer.

In this way, it will be understood by an ordinary person in the art to which the present invention pertains that the technical features of the present invention can be carried out in different detailed forms without changing the technical spirits or essential features of the present invention. Therefore, the above-described embodiments should be understood to be exemplary and not restrictive in all aspects, and it is construed that the scope of the present invention is determined not by the detailed description but by the claims and the meanings and ranges of the claims, and all changes or modifications derived from the equivalent concepts also fall within the scope of the present invention.

### DESCRIPTION OF REFERENCE NUMERALS

10: body
20: body housing
40: rotary wing part
41: driving motor
60: control unit
70: photo sensor
100: drone
110: second communication unit
120: memory unit
130: navigation photo sensor
140: shooting-down effect generating unit
200: laser gun
220: laser pointer
230: firing vibration unit
240: firing sound generating unit
300: ground station
310: preparation step
320: flight step
330: firing step
340: shooting-down step

1. A shooting system using a drone comprising:
a laser gun configured to fire laser light; and
a drone which is a target of the laser light,
wherein the drone includes:
a drone body including a photo sensor configured to receive the laser light fired by the laser gun; and
a control unit configured to control a taking-off/landing and flight trajectory of the drone, and
wherein a flight mode is controlled such that the drone is shot down by the control unit when the photo sensor receives the laser light.

2. The shooting system of claim 1, wherein the laser gun includes:
a laser pointer unit configured to generate and fire the laser light;
a firing vibration unit configured to generate vibration depending on a shooting as a portion of the laser gun is moved back when the laser light is fired; and
a firing sound unit configured to generate a sound when the laser light is fired.

3. The shooting system of claim 1, further comprising:
a ground station configured to transmit and receive signals to and from the control unit,
wherein the control unit generates a shooting-down effect according to a program stored in advance when the drone receives the laser light.

4. A shooting method using a drone comprising:
a preparation step of preparing a drone to which a taking-off/landing and flight trajectory is set, and a laser gun configured to fire laser light;
a flight step of flying the drone;
a firing step of laser light toward the flying drone with the laser gun; and
a shooting-down step of shooting down the drone as the drone receives the laser light fired by the laser gun.

5. The shooting method of claim 4, wherein in the firing step, the laser gun generates a firing sound at the same time when the laser light is fired, and generates vibration after the laser light is fired.
